(19) United States
(12) Patent Application Publication
(10) Pub. No.: US 2019/0226556 A1
(43) Pub. Date: Jul. 25, 2019

(54) FINAL DRIVE FOR A MOTOR VEHICLE

(71) Applicant: AUDI AG, Ingolstadt (DE)

(72) Inventors: Christian MEIXNER, Ingolstadt (DE); Hans-Jürgen LANGHOFF, Lenting (DE)

(73) Assignee: AUDI AG, Ingolstadt (DE)

(21) Appl. No.: 16/337,516

(22) PCT Filed: Sep. 19, 2017
(86) PCT No.: PCT/EP2017/073683

§ 371 Date: Mar. 28, 2019

(30) Foreign Application Priority Data
Sep. 28, 2016 (DE) 10 2016 218 740.6

(51) Int. Cl. F16H 1/22; F16H 57/021; F16H 57/038

(52) U.S. Cl. CPC F16H 1/222; F16H 57/038; F16H 57/021

(57) ABSTRACT

A final drive for a motor vehicle, including a first input shaft, a second input shaft, a first output shaft and a second output shaft, wherein the first input shaft is permanently coupled to the first output shaft by means of a first bevel-gear transmission and the second input shaft is permanently coupled to the second output shaft by means of a second bevel-gear transmission. The first input shaft and the second input shaft are coaxial and the first output shaft and the second output shaft extend from the respective bevel-gear transmission in opposite directions, wherein axes of rotation of the output shafts intersect each other or are arranged parallel or askew to each other.

The invention relates to a final drive for a motor vehicle, having a first input shaft, a second input shaft, a first output shaft and a second output shaft, wherein the first input shaft is permanently coupled to the first output shaft by means of a first bevel-gear transmission and the second input shaft is permanently coupled to the second output shaft by means of a second bevel-gear transmission.

The final drive is associated with an axle of the motor vehicle, i.e., a front axle, for example, but preferably a rear axle of the motor vehicle. By means of the final drive, a torque is transferred from a drive device of the motor vehicle to wheels of the motor vehicle. In other words, an operative connection between the drive device of the motor vehicle and the axle or its wheels is established or at least able to be established via the final drive. The drive device is permanently coupled or at least couplable to the first input shaft and the second input shaft. For example, the operative connection between the drive device and the two input shafts is via a transmission device other than the final drive. As an example, the transmission device may be designed as a differential gear, in particular as an axle differential gear. Then, the two input shafts may be in the form of universal joints or at least be coupled, in particular permanently, to universal joints.

For example, the two input shafts of the final drive are permanently, in particular rigidly, coupled to the output shafts of the transmission device. The two output shafts of the final drive are provided on the side of the wheel, i.e., regarding a flow of torque, on a side of the bevel-gear transmission facing away from the drive device. For example, the first output shaft is associated with, in particular permanently and/or rigidly coupled to, a first wheel of the axle and the second output shaft with at least one second wheel of the same axle. It is understood, however, that it may be contemplated to have the operative connection between the first output shaft and the first wheel and/or the operative connection between the second output shaft and the second wheel at least temporarily interruptible. For this purpose, a clutch, e.g., a dog clutch, may be provided within each operative connection.

Within the final drive, the first input shaft is permanently coupled to the first output shaft and the second input shaft is permanent coupled to the second output shaft. This is achieved by means of the first bevel-gear transmission and the second bevel-gear transmission. Using the bevel-gear transmission, an arrangement is achieved in which the input shafts and the output shafts are at an angle to each other. As an example, it may be contemplated in this respect that each of the bevel-gear transmissions has a hypoid offset such that the output shafts are offset from the input shafts, in particular askew relative to them, i.e., arranged parallel to and spaced apart from them. However, this results in a large installation space required for the final drive.

It is an object of the invention to propose a final drive for a motor vehicle which has advantages over known final drives, in particular low requirements as to installation space.

According to the invention, this is achieved by a final drive having the features of claim 1. Therein, it is provided that the first input shaft and the second input shaft are coaxial with each other, and that the first output shaft and the second output shaft extend in opposite directions from the respective bevel-gear transmission, wherein axes of rotation of the output shafts intersect or are arranged parallel or askew to each other.

Therefore, overall, a special arrangement of the input shafts and the output shafts is provided first of all. In turn, it may also enable a special design of the drive housing which is preferably comprised of multiple components. Firstly, the two input shafts are coaxial with each other. For example, the second input shaft extends within the first input shaft, or vice versa. The two output shafts are substantially opposite to each other, in particular with respect to a plane of symmetry, and extend from the respective bevel-gear transmission in opposite directions, preferably in the direction of the relevant wheel of the motor vehicle, respectively.

For example, both the axis of rotation of the first output shaft and the axis of rotation of the second output shaft intersect the two axes of rotation of the input shafts or the common axis of rotation of the input shafts. In other words, it is intended that axes of rotation of the output shafts each intersect the axes of rotation of the input shafts. Accordingly, the bevel-gear transmissions may preferably be formed without a hypoid offset. However, it is also possible to implement a design with a hypoid offset, resulting in at least the axis of rotation of one of the output shafts not intersecting the axes of rotation of the input shafts. However, preferably, the axes of rotation of both output shafts do not intersect the axes of rotation of the input shafts in this case. Thus, overall, there is an askew arrangement of the axes of rotation of the output shafts with respect to the axes of rotation of the input shafts.

In this respect, it may be contemplated that the axes of rotation of the output shafts intersect each other or are arranged parallel or askew to each other. In the former case, the two axes of rotation intersect each other at an intersection which is preferably on the axes of rotation of the input shafts. In this case, the axes of rotation of the output shafts then intersect the axes of rotation of the input shafts in exactly one single intersection. Here, it may be intended for the axes of rotation of the output shafts to be at an angle to each other or to lie within a common plane. In the latter case, the two output shafts are coaxial with each other.

A parallel arrangement of the axes of rotation of the output shafts with respect to each other may also be contemplated. The parallel arrangement of the output shafts is understood to be an arrangement in which the axes of rotation of the output shafts do not intersect. Where each of the axes of rotation of the output shafts intersects the axes of rotation of the input shafts, in a preferred design, then two intersections exist between the axes of rotation of the output shafts and the axes of rotation of the input shafts, which are spaced apart from each other. The first output shaft then intersects the axes of rotation of the input shafts in a first intersection and the second output shaft in a second intersection. The two intersections, namely the first intersection and the second intersection, are spaced apart from each other in the axial direction with respect to the axes of rotation of the input shafts. In a further embodiment of the invention, an askew arrangement of the output shafts may be implemented with respect to each other. This means an arrangement of the output shafts such that their axes of rotation neither intersect nor are arranged parallel to each other.

In a further preferred embodiment of the invention, an axial plane incorporates the axes of rotation of the input shafts and a plane perpendicular to the axial plane encloses an angle of at least 75° and no more than 90° with each of the axes of rotation of the output shafts, and/or the axes of rotation of the two input shafts and the axes of rotation of the two output shafts are within the axial plane. It is also provided that the (imaginary) axial plane incorporates the axes of rotation of the input shafts. With respect to an installation position of the final drive, the axial plane is substantially arranged horizontally. Accordingly, the plane which is perpendicular to the axial plane and also incorporates the axes of rotation of the input shafts is a vertical plane, i.e., it is substantially arranged perpendicularly in the installation position of the final drive. At least seen in section, in particular in cross-section with respect to the axes of rotation of the input shafts, the plane perpendicular to the axial plane encloses an angle of at least 75° and no more than 90° with each of the axes of rotation of the output shafts.

Hence, each of the axes of rotation encloses an angle with the plane, fulfilling the requirements mentioned. The angle between the axes of rotation and the plane may be identical, but may alternatively be different from each other. For example, the angle is or the angles are at least 75° and no more than 90°. Preferably, the angle is or the angles are at least 80°, at least 85°, at least 86°, at least 87°, at least 88° or at least 89°, but always no more than 90°. This means that the angle or the angles could be exactly equal to 90° or could be smaller than 90°.

Additionally or alternatively, at least seen in section, i.e., in particular in cross-section with respect to the axes of rotation of the input shafts, the plane perpendicular to the axial plane is a plane of symmetry for the axes of rotation of the output shafts.

In this case, the axes of rotation of the output shafts are then arranged or oriented symmetrically to each other with regard to the plane of symmetry. This means, in particular, that the axes of rotation enclose the same angle with the plane of symmetry in a plane or in planes parallel to each other, i.e., are at an identical angle with respect to the plane of symmetry. Additionally or alternatively, it may be provided that the axes of rotation of the two input shafts and the axes of rotation of the two output shafts lie within the axial plane. This constitutes a particularly advantageous orientation of the input shafts and the output shafts, enabling a very compact design of the final drive. If both the input shafts and the output shafts are arranged in the axial plane, the definition described above using the plane of symmetry can be omitted. It is then no longer required for defining the axial plane.

In a preferred embodiment of the invention, a first bevel gear of the first bevel-gear transmission rigidly connected to the first output shaft and/or a second bevel gear of the second bevel-gear transmission rigidly connected to the second output shaft is/are each supported by means of a first radial bearing and a second radial bearing within a drive housing of the final drive. The first bevel gear is part of the first bevel-gear transmission, the second bevel gear is part of the second bevel-gear transmission. At least one of these bevel gears, but preferably both bevel gears, are now supported by two radial bearings, namely the first radial bearing and the second radial bearing, each within the drive housing of the final drive.

In a further design of the invention, the first radial bearing and the second radial bearing are arranged in a tandem arrangement or in a face-to-face arrangement, or one of the radial bearings is formed as a fixed baring and the other one of the radial bearings is formed as a movable bearing. The two radial bearings are arranged in a tandem arrangement or in a face-to-face arrangement with respect to each other. Alternatively, they may also be formed as a fixed bearing and as a movable bearing. In the latter case, one of the radial bearings constitutes the fixed bearing and the other one of the radial bearings constitutes the movable bearing. Such an arrangement and/or design of the radial bearings enables a reliable and compact support of the bevel gear or bevel gears at and/or within the drive housing.

In a preferred embodiment of the invention, when seen in cross-section with respect to the axes of rotation of the input shafts, the output shafts are symmetrically arranged at an angle relative to a central plane incorporating the axes of rotation of the input shafts. This was already mentioned above. The central plane may correspond to the plane of symmetry mentioned above. It then incorporates the axes of rotation of the input shafts and may also be arranged perpendicularly to the axial plane. When seen in cross-section, the output shafts or their axes of rotation should now be at an angle symmetrically to the central plane, i.e., enclose the same angle with it.

In the simplest case, the two output shafts or their axes of rotation are perpendicular to the central plane. However, they may also enclose an angle therewith, which may be different from 90°, again in particular when seen in cross-section. In this respect, the output shafts or their axes of rotation are inclined in the same direction with respect to the central plane. Thus, as an example, the axes of rotation of the output shafts enclose the same angle with the central plane and are each inclined away from the axial plane, e.g.—with respect to the installation position of the final drive—upwards or downwards.

In a further embodiment of the invention, the output shafts are offset parallel to each other. Preferably, this means that the output shafts indeed extend in parallel in the three-dimensional sense. However, it may also be contemplated that the output shafts only appear to be arranged parallel to each other only in a certain viewing direction, e.g., in a top view. In this case, the output shafts or their axes of rotation are arranged askew to each other as they neither intersect nor are actually parallel to each other. This particularly applies if the axes of rotation of the output shafts intersect the axes of rotation of the input shafts in two intersections spaced apart from each other and are, at the same time, symmetrically arranged at an angle other than 90° with respect to the central plane.

In a further embodiment of the invention, it may be contemplated for each of the axes of rotation of the output shafts to be perpendicular to the axes of rotation of the input shafts or to be arranged at an angle, in particular at an angle in opposite directions, to the axes of rotation of the input shafts. Preferably, there is a right angle between each of the axes of rotation of the output shafts and the axes of rotation of the input shafts in at least one direction in space, preferable in at least two directions in space. However, in at least another one of the directions in space, i.e., exactly one direction in space or two directions in space, for example, one of the axes of rotation of the output shafts is at an angle other than a right angle with respect to the axes of rotation of the input shafts.

Preferably, the angles at which they intersect the axes of rotation of the input shafts are identical for both axes of rotation of the output shafts. However, in this respect, the axes of rotation of the output shafts may be at an angle in opposite directions with respect to the axes of rotation of the input shafts such that, though the angles have the same absolute value, they have different signs. As an example, according to the foregoing, this may be implemented such that the output shafts or their axes of rotation are inclined in the same direction with respect to the axial plane, i.e., have an increasing distance therefrom outwardly in the axial direction. In this respect, the output shafts or their axes of rotation are on the same side of the axial plane. In principle, it could also be implemented to have the axes of rotation of the output shafts at an angle in opposite directions with respect to the axes of rotation of the input shafts. In this case, the output shafts or their axes of rotation are on different sides of the axial plane.

In a further design of the invention, a bearing element is arranged within the drive housing, having a first bearing projection and a second bearing projection, wherein the bevel gear of the first bevel-gear transmission is supported on the first bearing projection and the bevel gear of the second bevel-gear transmission is supported on the second bearing projection. In order to design the final drive in a particularly compact manner, the bearing element is arranged within the drive housing. The bearing element includes both bearing projections, namely the first bearing projection and the second bearing projection. The bearing projections are used to support bevel gears of both bevel-gear transmissions. Then, the first bevel gear of the first bevel-gear transmission is supported on the first bearing projection and the second bevel gear of the second bevel-gear transmission is supported on the second bearing projection.

Preferably, the support is designed to be direct such that the respective bevel gear rests on the corresponding bearing projection. However, alternatively, a mere indirect support may be contemplated in which the bevel gears are supported on the bearing projection via the respective output shaft, for example. With such a design, the output shaft rests on or at the bearing projection indirectly. The support of the respective bevel gear is only provided indirectly via the output shaft. Here, the bevel gear may be spaced apart from the bearing projection in the axial direction with respect to its axis of rotation or the axis of rotation of the output shaft, for example. The first bevel gear is rigidly connected to the first output shaft or, alternatively, integral with it. The same may analogously apply to the second bevel gear and the second output shaft.

The bearing element is a device formed separately from the drive housing. Hence, at first, the drive housing and the bearing element are manufactured separately from each other and then the bearing element is arranged at or within the drive housing. Preferably, the bearing element is arranged centrally within the drive housing, in particular centrally with respect to the axes of rotation of the two input shafts. In particular, the axes of rotation of the two input shafts extend through the bearing element, thus intersecting it. In order to enable a simple arrangement of the bearing element within the drive housing, it is preferably designed to be comprised of multiple components and has, for this purpose, a first housing shell and a second housing shell, for example. As an example, the two bearing projections are round in cross-section with respect to their respective longitudinal central axis and preferably extend in the axial direction from a central pin of the bearing element. Preferably, at their end facing away from the central pin, the bearing projections each have a free end.

In a further embodiment of the invention, the first bearing projection and/or the second bearing projection is coaxial with the respective output shaft. Then, what was described for the output shaft or its axis of rotation analogously applies to at least one of the bearing projections, but preferably both bearing projections. This means that a longitudinal central axis of the first bearing projection and/or a longitudinal central axis of the second bearing projection coincides with the axis of rotation of the corresponding output shaft.

Finally, in a particularly preferred embodiment of the invention, it may be contemplated that the first bearing projection and the second bearing projection extend from a central pin of the bearing element and are each at an angle thereto. The central pin is then located between the two bearing projections, extending therefrom on opposite sides of the central pin. For example, the central pin is arranged approximately at the center within the drive housing, preferably centrally with respect to the axes of rotation of the input shafts. Preferably, the axes of rotation of the input shafts extend at least through the bearing element, but in particular through the central pin.

Hence, the bearing projections each enclose an angle greater than 0° and smaller than 180° with the central pin or a longitudinal central axis of the central pin. Thus, the central pin is preferably arranged centrally and symmetrically within the drive housing. For example, its longitudinal central axis coincides with the plane of symmetry or is at least perpendicular to the axial plane. Then, there is no oblique arrangement of the central pin arranged within the drive housing. Instead, the angled arrangement of the bearing projections at the central pin is provided for the desired orientation of the output shafts or their axes of rotation. This allows for a very easy installation of the final drive.

In the following, the invention is explained in more detail by means of the exemplary embodiments shown in the drawing without limiting the invention. Therein:

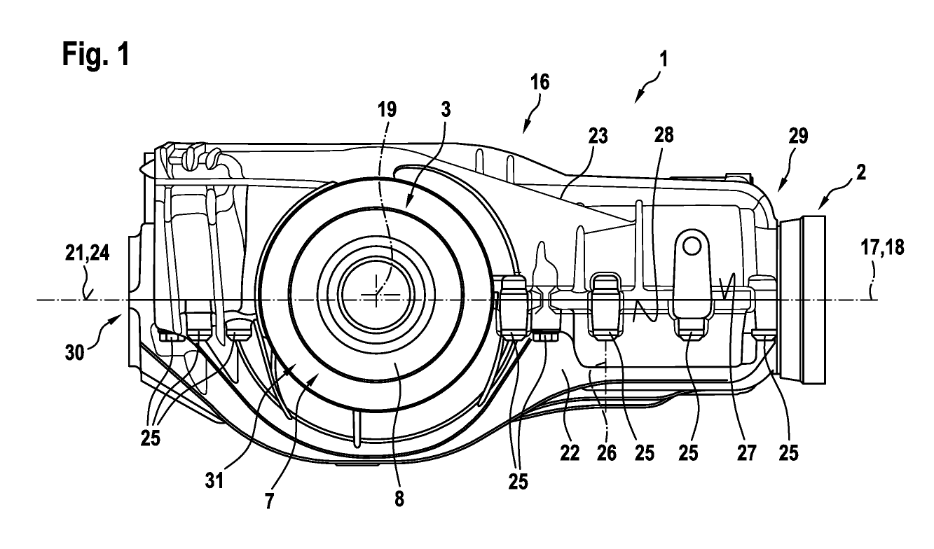

FIG. 1 shows a schematic side view of a final drive 1 for a motor vehicle. It includes a first input shaft 2 of which a connecting flange 3 is shown here. Coaxially with first input shaft 2, a second input shaft 4 is arranged which cannot be seen here. For this purpose, first input shaft 2 is designed as a hollow shaft and second input shaft 4 is arranged and/or support in first input shaft 2. Second input shaft 4 has a connecting flange 5 which is preferably arranged in connecting flange 3 of first input shaft 2. First input shaft 2 is permanently coupled to a first output shaft 7 by means of a first bevel-gear transmission 6. First output shaft 7 includes a connection flange 8 which can be seen here. Analogously, second input shaft 4 is permanently coupled to a second output shaft 10, which cannot be seen here and includes a connecting flange 11, via a second bevel-gear transmission 9.

First bevel-gear transmission 6 is comprised of a bevel gear 12 rigidly and permanently coupled to first input shaft 2 and a second bevel gear 13 brushing bevel gear 12 and permanently and rigidly connected to first output shaft 7. Analogously, second bevel-gear transmission 9 has a bevel gear 14 rigidly and permanently coupled to second input shaft 4 and a bevel gear 15 brushing bevel gear 14 and rigidly and permanently coupled to second output shaft 10. Bevel-gear transmissions 6 and 9 and correspondingly bevel gears 12, 13, 14 and 15 are, in particular completely, arranged within a drive housing 16 of final drive 1. In other words, it is preferred for drive housing 16 to completely include bevel-gear transmissions 6 and 9.

As already mentioned, first input shaft 2 and second input shaft 4 are coaxial with each other, with second input shaft 4 being located within first input shaft 2. Hence, input shafts 2 and 4 have axes of rotation 17 and 18 coinciding with each other. First output shaft 7 and second output shaft 10 now extend from the respective bevel-gear transmission 6 or 9 in opposite directions. Thus, in the exemplary embodiment shown herein, first output shaft 7 extends out of the drawing plane, while second output shaft 10 extends into the drawing plane. An axis of rotation 19 of first output shaft 7 or of each connecting flange 8 is arranged slightly obliquely in the vertical direction and intersects axes of rotation 17 and 18. The same applies to an axis of rotation 20 of second output shaft 10 or its connecting flange 11, which cannot be seen here.

Input shafts 2 and 4 or their axes of rotation 17 and 18 lie within an axial plane 21 which is generally arranged horizontally. In other words, an imaginary plane is perpendicular to axial plane 21, which is provided as a plane of symmetry for axes of rotation 19 and 20 of output shafts 7 and 10 when seen in section, in particular in cross-section with respect to axes of rotation 17 and 18. Axes of rotation 19 and 20 are then arranged and oriented symmetrically to said imaginary plane which may also be referred to as a vertical plane due to the horizontal arrangement of axial plane 21.

As the imaginary plane is used as a plane of symmetry for axes of rotation 19 and 20, axes of rotation 19 and 20 intersect both the plane of symmetry and the axial plane each at the same angle. Hence, in other words, axis of rotation 19 is at a first angle with respect to axial plane 21 or the plane of symmetry and axis of rotation 20 is at a second angle with respect to axial plane 21 or the plane of symmetry, both angles being equal. Most generally, axes of rotation 19 and 20 then intersect axial plane 21. It may also be provided for axes of rotation 19 and 20 to be completely within axial plane 21.

In order to enable a space-efficient design of final drive 1, drive housing 16 may be designed to be comprised of multiple components and then has a first housing shell 22 and a second housing shell 23 formed separately from each other and abutting each other in a contact plane 24 lying within axial plane 21 or parallel thereto. First housing shell 22 and second housing shell 23 are screwed to each other by means of at least one screw 25, in the exemplary embodiment shown herein, by means of a plurality of screws 25. At least one of screws 25, but preferably all of screws 25, now have a longitudinal central axis 26 which is at an angle with respect to contact plane 24, i.e., intersects it at a certain angle.

Then, it is not intended for screw 25 or its longitudinal central axis 26 to be arranged parallel to contact plane 24 or for longitudinal central axis 26 to lie within contact plane 24. Instead, it is particularly preferred for longitudinal central axis 26 to be perpendicular to contact plane 24. In addition, it is preferred that at least one of screws 25 is passed through by contact plane 24, i.e., intersected by contact plane 24.

For the arrangement of screw 25, this means that it is located laterally on drive housing 16 and not in a separate mounting flange provided at an upper surface or lower surface of drive housing 16 for fastening shells 22 and 23 to each other. In the advantageous design of final drive 1 described herein, such a mounting flange is simply not provided for. Such a design allows to significantly reduce the installation space required in the vertical direction, i.e., in the plane of symmetry, in comparison to other final drives 1.

At first housing shell 22, there is a first planar abutment surface 27 lying within contact plane 24, and at second housing shell 23, there is a second planar abutment surface 28 lying within contact plane 24. Upon mounting housing shells 22 and 23, the two abutment surfaces 27 and 28 lie flush, in particular fully flush, against each other. The fully flush arrangement is understood to mean that the entire first abutment surface 27 abuts the entire second abutment surface 28. Each of abutment surfaces 27 and 28 then fully covers the other abutment surface 28 or 27 completely.

Screw 25 now passes through both first abutment surface 27 and second abutment surface 28. It then passes into both first housing shell 22 and second housing shell 23 to fasten them to each other. In the exemplary embodiment shown herein, it is intended for first abutment surface 27 to extend in the direction of axes of rotation 17 and 18 from one end 29 of drive housing 16 to its other end 30. Additionally or alternatively, this applies to second abutment surface 28. It is particularly preferred for both first abutment surface 27 and second abutment surface 28 to extend up to end 29, on the one hand, and up to end 30, on the other hand.

However, between ends 29 and 30, abutment surfaces 27 and 28 could be interrupted. In the exemplary embodiment shown herein, this holds true for both abutment surfaces due to a first outlet opening 31 for first output shaft 7 or its connecting flange 8 and a second outlet opening 32 for second output shaft 10 or its connecting flange 11. First output shaft 7 then passes through first outlet opening 31 or is arranged therein, while second output shaft 10 passes through second outlet opening 32 or is arranged therein.

It is particularly preferred for outlet openings 31 and 32 to each be formed in housing shell 22 and second housing shell 23 in equal proportions. However, at least, each of outlet openings 31 and 32 is at least partially located within first housing shell 22 and at least partially located within second housing shell 23. Abutment surfaces 27 and 28 then each have two subareas which are located on opposite sides of outlet openings 31 and 32 when seen in the axial direction with respect to axes of rotation 17 and 18.

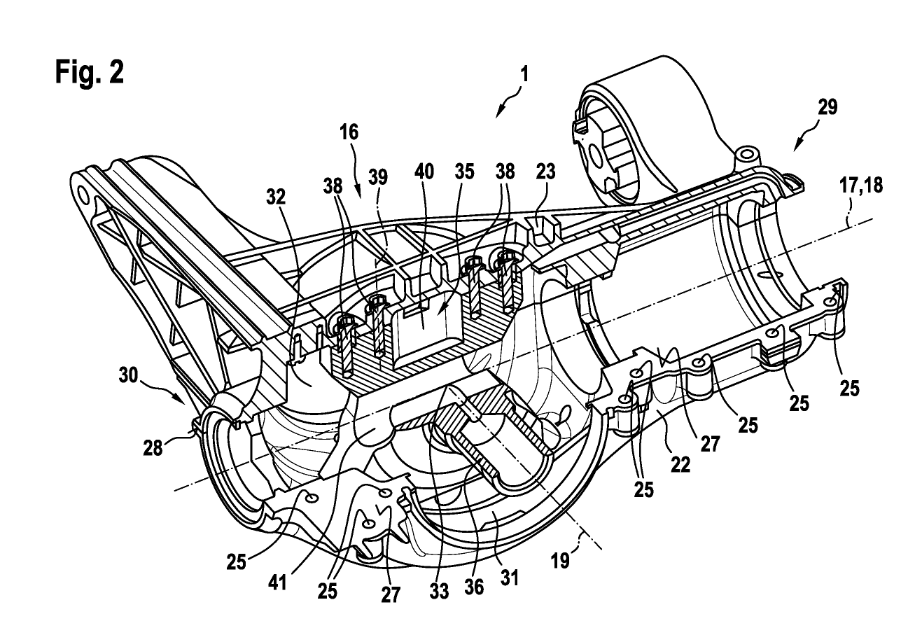

FIG. 2 shows a partial schematic sectional view of a part of final drive 1. Therein, input shafts 2 and 4 and output shafts 7 and 10 are not shown. This also applies to bevel-gear transmissions 6 and 9. Generally, however, the foregoing is still made reference to. Here, it can be seen clearly that axis of rotation 19 intersects axes of rotation 17 and 18 at an intersection 33. This analogously applies for axis of rotation 20 at an intersection 34 not shown here, wherein the latter may coincide with intersection 33.

Furthermore, it can now be seen that, in a preferred design of final drive 1, a bearing element 35 is arranged within drive housing 16. It includes a first bearing projection 36 and an opposite second bearing projection 37 which cannot be seen here. First bevel gear 13 rigidly connected to first output shaft 7 is rotatably supported on first bearing projection 36 and second bevel gear 15 of second bevel-gear transmission 9 rigidly connected to second output shaft 10 is rotatably supported on second bearing projection 37. Here, first bearing projection 36 protrudes in the direction of first outlet opening 31, in particular protruding therein or even passing therethrough in the direction of axis of rotation 19. Conversely, second bearing projection 37 protrudes in the direction of second outlet opening 32. It too may protrude therein or even pass therethrough in the direction of axis of rotation 20.

Now, bearing element 35 is fastened to first housing shell 22, on the one hand, and to second housing shell 23, on the other hand. The fastening is achieved using at least one screw 38 each, preferably using multiple screws 38 each. Here, this can only be seen with the fastening of bearing element 35 at second housing shell 23. However, preferably, the relevant description may also be applicable to the fasting of bearing element 35 to first housing shell 22. It can be seen that screw 38 or screws 38 each have a longitudinal central axis 39. Screw 38 or its longitudinal central axis 39 is now at an angle with respect to contact plane 24 (not shown here). In particular, it is perpendicular to contact plane 24. This also means that longitudinal central axis 39 of screw 38 is preferably oriented parallel to longitudinal central axis 26 of screw 25.

In order to retain bearing element 35 on drive housing 16, screw 38 engages a central pin 40 of bearing element 35. From central pin 40, bearing projections 36 and 37 protrude on opposite sides of the plane of symmetry. Moreover, a through-opening 41 may be formed in central pin 40, in particular between bearing projections 36 and 37, for receiving second input shaft 4. Preferably, second input shaft 4 then completely passes through bearing element 35, in particular its through-opening 41, in the axial direction with respect to axes of rotation 17 and 18.

In this respect, bevel-gear transmissions 6 and 9 are designed such that bevel gears 12 and 14 connected to input shafts 2 and 4 are located on opposite sides of bearing element 35, i.e., on opposite sides of a plane perpendicular to axes of rotation 17 and 18. In particular, bevel gear 12 is completely located on one side of said plane and bevel gear 14 is completely located on the opposite side of said plane. Bearing element 35 preferably has an integral design and/or is made of the same material. For example, it may be made of the same material as housing shells 22 and 23. The use of bearing element 35 enables a particularly compact design of final drive 1, in particular in the vertical direction.

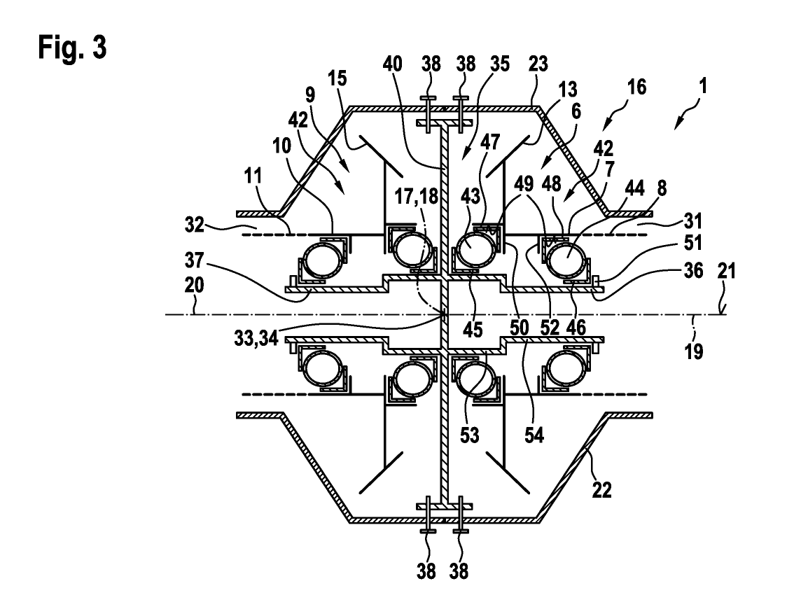

FIG. 3 shows a schematic sectional view of final drive 1, namely a cross-section with respect to axes of rotation 17 and 19, wherein the sectional plane is perpendicular to axes of rotation 17 and 18 and preferably incorporates axes of rotation 19 and 20. The viewing direction in the cross-section is directed in the direction of end 29. Input shafts 2 and 4 are not shown here. It can be seen that each of bevel gears 13 and 15 or each of output shafts 7 and 10 are each supported within drive housing 16 by means of a bearing arrangement 42. Bearing arrangements 42 for bevel gears 13 and 15 or corresponding output shafts 7 and 10 are designed analogously, in particular as mirror images. In the following, bearing arrangement 42 for bevel gear 13 or first output shaft 7 is described in more detail. However, such description is always applicable to bearing arrangement 42 for bevel gear 15 or second output shaft 10.

Bearing arrangement 42 includes a first radial bearing 43 and a second radial bearing 44. They are arranged on a back-to-back arrangement with respect to each other. Alternatively, they may also be formed as a fixed bearing and a movable bearing. In the latter case, one of radial bearings 43 and 44 constitutes the fixed bearing and the other one of radial bearings 43 and 44 constitutes the movable bearing. However, in the following, the back-to-back arrangement shown here will be described in more detail. However, the description is always applicable to the design of radial bearings 43 and 44 as a fixed bearing and a movable bearing. Preferably, radial bearings 43 and 44 are designed as roller bearings, in particular as ball bearings.

Radial bearings 43 and 44 are both arranged on first bearing projection 36. This means that they rest on first bearing projection 36 with their inner races 45 and 46. By contrast, outer races 47 and 48 of radial bearings 43 and 44 are arranged within bevel gear 13 and/or first output shaft 7. Accordingly, outer races 47 and 48 abut an inner bearing surface 49 of bevel gear 13 or first output shaft 7. It is intended for first radial bearing 43 to be supported on central pin 40 of bearing element 35 in the axial direction with respect to axis of rotation 19. In other words, first radial bearing 43 is arranged in the axial direction with respect to axis of rotation 19 between central pin 40 and bevel gear 13 or an axial bearing projection 50 of bevel gear 13. In particular, radial bearing 43 permanently abuts central pin 40 and also permanently abuts axial bearing projection 50.

Second radial bearing 44 is preferably fixed outwardly in the axial direction, i.e., in the direction facing away from central pin 40, by means of a fastener 51. As an example, a circlip or the like is used as fastener 51. In particular, fastener 51 is able to be removed again. Radial bearing 44 is preferably arranged between fastener 51 and bevel gear 13 or an axial bearing projection 52 of bevel gear 13 or first output shaft 7. Preferably, second radial bearing 44 permanently abuts fastener 51, on the one hand, and permanently abuts axial bearing projection 52, on the other hand.

Axial bearing projections 50 and 52 may be different from each other or, in particular, be spaced apart from each other in the axial direction. However, axial bearing projections 50 and 52 may also be designed as a common axial bearing projection, wherein first radial bearing 43 is located on one side and second radial bearing 44 is located on the side of this common axial bearing projection facing away in the axial direction. Clearly, bearing arrangement 42, i.e., both first radial bearing 43 and second radial bearing 44, is fastened to drive housing 16 via bearing element 35 only. Hence, radial bearings 43 and 44 only engage with drive housing 16 via bearing element 35.

Furthermore, it can be seen that first bearing projection 36 has a first portion 53 and a second portion 54 which differ from each other in diameter. Thus, first bearing projection 36 has a first diameter in the first portion 53 and a second diameter in the second portion 54, wherein the first diameter is greater than the second diameter. Preferably, first portion 53 is directly adjacent to central pin 40, in any case it is arranged on the side of second portion 54 facing towards central pin 40. Both portions 53 and 54 are preferably directly adjacent to each other in the axial direction with respect to axis of rotation 19.

Now, first radial bearing 43 rests on first bearing projection 36 in first portion 53 and second radial bearing 44 rest thereon in second portion 54. Inner race 45 then has a larger diameter than inner race 46. Preferably, radial bearings 43 and 44 are equally sized in the radial direction such that, analogously to inner races 45 and 46, outer race 47 has a larger diameter than outer race 48. It is understood, however, that radial bearings 43 and 44 may be selected such that the diameter difference between inner races 45 and 46 is different from the diameter difference of outer races 47 and 48. In this respect, for example, inner races 45 and 46 are configured with different diameters, while outer races 47 and 48 have the same diameter.

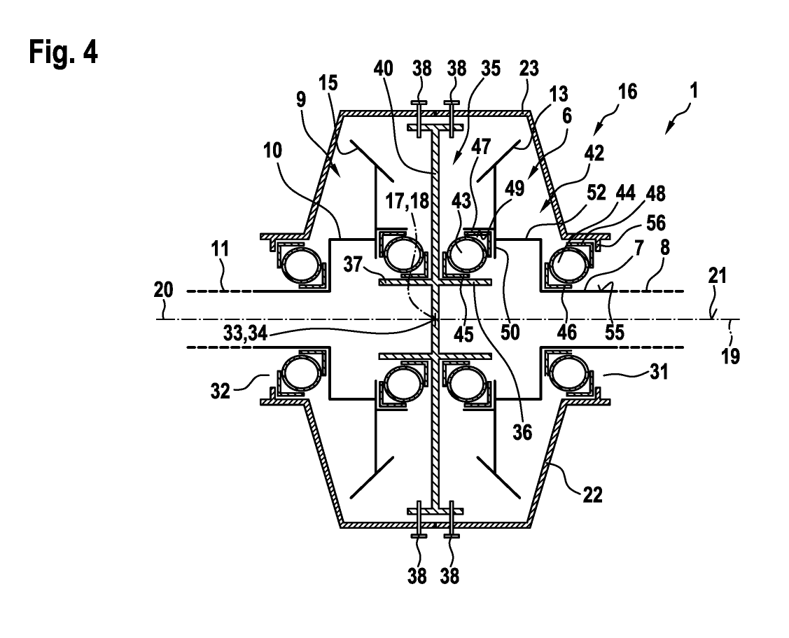

FIG. 4 shows a second embodiment of final drive 1, again in a sectional view. Generally, reference is made to the foregoing and only the differences are discussed in the following. Those are that radial bearings 43 and 44 of bearing arrangement 42 are now arranged in a tandem arrangement with respect to each other. Alternatively, an arrangement of radial bearings 43 and 44 in a face-to-face arrangement or again—as already explained above—a design of radial bearings 43 and 44 as a fixed bearing and a movable bearing is also possible. In the following, the tandem arrangement is described in more detail. However, the description is applicable to the back-to-back arrangement and the design as a fixed bearing and a movable bearing.

First radial bearing 43 is arranged analogously to the first embodiment of final drive 1. Accordingly, it rests on first bearing projection 36 with its inner race 45. In the axial direction, it is preferably supported on central pin 40, on the one hand, and on axial bearing projection 50, on the other hand. However, there are differences regarding second radial bearing 44. It rests on an outer bearing surface 55 of bevel gear 13 or first output shaft 7 with its inner race 45. Hence, while first radial bearing 43 engages with bevel gear 13 or output shaft 7, second radial bearing 44 surrounds bevel gear 13 or output shaft 7. As a result, first bearing projection 36 may be shorter and have a uniform diameter. Fastener 51 may also be omitted.

Second radial bearing 44 engages with bevel gear 13 or output shaft 7, on the one hand, and directly engages with drive housing 16, in particular at both housing shells 22 and 23, on the other hand. Now, axial bearing projection 52 is formed by an abutment shoulder of bevel gear 13 or output shaft 7. Again, this may be shown by a change in diameter. In order to fix second radial bearing 44 in the axial direction with respect to drive housing 16 at least to the outside, drive housing 16 also has an axial bearing projection 56. Preferably, it is formed on both first housing shell 22 and on second housing shell 23. When seen in the axial direction with respect to axis of rotation 19, second radial bearing 44 is now located between axial bearing projection 52 and axial bearing projection 56. It is particularly preferred for it to permanently abut axial bearing projection 52, on the one hand, and permanently abut axial bearing projection 56, on the other hand.

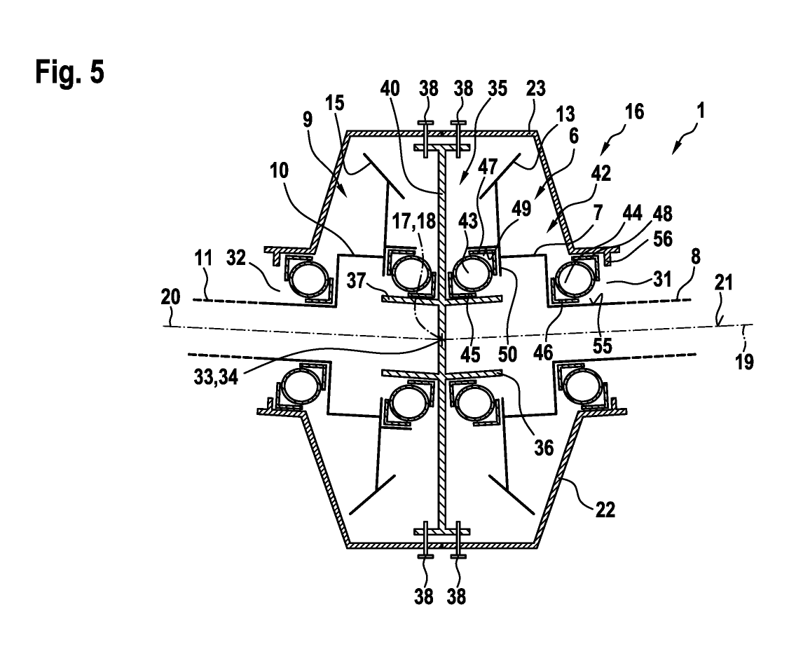

FIG. 5 shows a first variation of a third embodiment of final drive 1. Here again, a schematic cross-sectional view is shown in accordance with the foregoing. Bearing arrangement 42 is configured analogously to the second embodiment described above. However, a bearing arrangement 42 according to the first embodiment may also be used. In this respect, reference is made to the foregoing. In the following, only the differences from the first two embodiments are described. Those are that bevel gears 13 and 15 and, therefore, axes of rotation 19 and 20 are not parallel to each other, but are instead at an angle to each other.

This means that axes of rotation 19 and 20 still intersect axes of rotation 17 and 18 at intersections 33 and 34, wherein intersections 33 and 34 may coincide. Most generally, axes of rotation 19 and 20 each intersect both axes of rotation 17 and 18. Axes of rotation 19 and 20 may additionally intersect each other or, alternatively, may be arranged askew to each other, in particular spaced apart parallel to each other. In a first variation shown here, axes of rotation 19 and 20 intersect. Here, axes of rotation 19 and 20 are each located at the same angle to axial plane 21 or contact plane 24 such that the plane perpendicular to contact plane 24 and incorporating axes of rotation 17 and 18 serves as a plane of symmetry for axes of rotation 19 and 20.

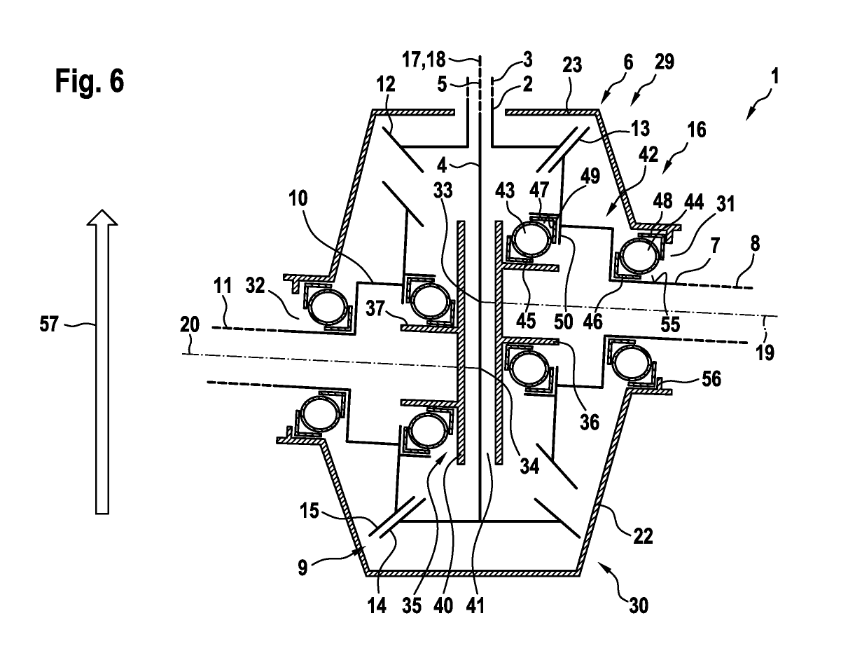

FIG. 6 shows a second variation of the third embodiment. Here, a sectional view through the final drive, i.e., a longitudinal sectional view with respect to axes of rotation 17 and 18, is shown. Therein, the sectional plane is selected such that there is a viewing direction towards first housing shell 22. Explicit reference is made to the foregoing. In addition thereto, it can be seen clearly here that bevel gears 12 and 14 of bevel-gear transmissions 6 and 9 are arranged on opposite sides of bearing element 35. For this purpose, second input shaft 4 passes—as already explained above—through bearing element 35, in particular it passes through through-opening 41. A travelling direction of a motor vehicle associated with final drive 1 is indicated by the arrow 57.

In addition or as an alternative to the first variation described above in which the axes of rotation 19 and 20 are at an angle with respect to the axial plane, it can now be contemplated that axes of rotation 19 and 20 are also offset from each other in the axial direction with respect to axes of rotation 17 and 18. For example, for this purpose, bevel-gear transmissions 6 and 9 may be designed such that an apex angle other than 90° is present. However, in the embodiments described above and the first variation, the apex angle is preferably equal to 90°. The mutual displacement of axes of rotation 19 and 20 in the axial direction results in two intersections 33 and 34 which are spaced from each other.

Final drive 1 described allows for a very compact design. This applies in particular if a further transmission device, in particular a differential gear, preferably an axle differential gear, is arranged on the side of input shafts 2 and 4 facing away from final drive 1. Thus, final drive 1 is only used to establish the permanent operative connections between first input shaft 2 and first output shaft 7, on the one hand, and second input shaft 4 and second output shaft 10, on the other hand.

1-10. (canceled)

11. A final drive for a motor vehicle, comprising:
a first input shaft, a second input shaft, a first output shaft and a second output shaft, wherein the first input shaft is permanently coupled to the first output shaft by a first bevel-gear transmission and the second input shaft is permanently coupled to the second output shaft by a second bevel-gear transmission, wherein the first input shaft and the second input shaft are coaxial to each other and the first output shaft and the second output shaft extend from the respective bevel-gear transmission in opposite directions, wherein axes of rotation of the output shafts intersect each other or are arranged parallel or askew to each other.

12. The final drive as claimed in claim 11, wherein an axial plane incorporates the axes of rotation of the input shafts and a plane perpendicular to the axial plane is provided as a plane of symmetry for the axes of rotation of the output shafts at least when seen in section, and/or that the axes of rotation of the two input shafts and the axes of rotation of the two output shafts lie within the axial plane.

13. The final drive as claimed in claim 11, wherein a first bevel gear of the first bevel-gear transmission rigidly connected to the first output shaft and/or a second bevel gear of the second bevel-gear transmission rigidly connected to the second output shaft is/are each supported by means of a first radial bearing and a second radial bearing within a drive housing of the final drive.

14. The final drive as claimed in claim 11, wherein the first radial bearing and the second radial bearing are arranged in a tandem arrangement or a face-to-face arrangement, or that one of the radial bearings is formed as a fixed bearing and the other one of the radial bearings is formed as a movable bearing.

15. The final drive as claimed in claim 11, wherein, when seen in cross-section with respect to the axes of rotation of the input shafts, the output shafts are arranged symmetrically at an angle to a central plane incorporating the axes of rotation of the input shafts.

16. The final drive as claimed in claim 11, wherein the output shafts are offset parallel to each other.

17. The final drive as claimed in claim 11, wherein the axes of rotation of the output shafts are each arranged at an angle, in particular at an angle in opposite directions, to the axes of rotation of the input shafts.

18. The final drive as claimed in claim 11, wherein a bearing element is arranged within the drive housing, having a first bearing projection and a second bearing projection, wherein the bevel gear of the first bevel-gear transmission is supported on the first bearing projection and the bevel gear of the second bevel-gear transmission is supported on the second bearing projection.

19. The final drive as claimed in claim 11, wherein the first bearing projection and/or the second bearing projection is/are coaxial with the respective output shaft.

20. The final drive as claimed in claim 11, wherein the first bearing projection and the second bearing projection extend from a central pin of the bearing element and are each arranged at an angle thereto.

21. The final drive as claimed in claim 12, wherein a first bevel gear of the first bevel-gear transmission rigidly connected to the first output shaft and/or a second bevel gear of the second bevel-gear transmission rigidly connected to the second output shaft is/are each supported by means of a first radial bearing and a second radial bearing within a drive housing of the final drive.

22. The final drive as claimed in claim 12, wherein the first radial bearing and the second radial bearing are arranged in a tandem arrangement or a face-to-face arrangement, or that one of the radial bearings is formed as a fixed bearing and the other one of the radial bearings is formed as a movable bearing.

23. The final drive as claimed in claim 13, wherein the first radial bearing and the second radial bearing are arranged in a tandem arrangement or a face-to-face arrangement, or that one of the radial bearings is formed as a fixed bearing and the other one of the radial bearings is formed as a movable bearing.

24. The final drive as claimed in claim 12, wherein, when seen in cross-section with respect to the axes of rotation of the input shafts, the output shafts are arranged symmetrically at an angle to a central plane incorporating the axes of rotation of the input shafts.

25. The final drive as claimed in claim 13, wherein, when seen in cross-section with respect to the axes of rotation of the input shafts, the output shafts are arranged symmetrically at an angle to a central plane incorporating the axes of rotation of the input shafts.

26. The final drive as claimed in claim 14, wherein, when seen in cross-section with respect to the axes of rotation of the input shafts, the output shafts are arranged symmetrically at an angle to a central plane incorporating the axes of rotation of the input shafts.

27. The final drive as claimed in claim 12, wherein the output shafts are offset parallel to each other.

28. The final drive as claimed in claim 13, wherein the output shafts are offset parallel to each other.

29. The final drive as claimed in claim 14, wherein the output shafts are offset parallel to each other.

30. The final drive as claimed in claim 15, wherein the output shafts are offset parallel to each other.
